(19) United States
(12) Patent Application Publication
(10) Pub. No.: US 2007/0194472 A1
(43) Pub. Date: Aug. 23, 2007

(54) PROCESS OF FABRICATING MICROLENS MOLD

(76) Inventors: Irizo Naniwa, Odawara (JP); Shigeo Nakamura, Odawara (JP); Masatoshi Kanamaru, Miho (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/624,268

(22) Filed: Jan. 18, 2007

(30) Foreign Application Priority Data
Feb. 17, 2006 (JP) 2006-041346

(51) Int. Cl. B29D 11/00

(52) U.S. Cl. 264/2.5

(57) ABSTRACT

A process for fabricating a mold for an aspherical microlens having a desired aspherical and smooth surface, the lens having an effective diameter of 1 mm or smaller and a thickness of 0.5 mm or greater. A double-layer mask layer is formed on a single crystal silicon substrate, and anisotropic etching and isotropic etching are carried out using a first mask layer so as to form a concave portion that is a little smaller than the size of a desired microlens mold. Isotropic etching is then carried out using a second mask layer so as to enlarge the concave portion, thereby obtaining a microlens mold having desired dimensions.

### BACKGROUND OF THE INVENTION

1. Field of the Invention

The invention relates to a process of fabricating a microlens mold, and particularly to a process of fabricating a mold for the molding of a miniature aspherical microlens having an effective diameter of 1 mm or smaller.

2. Background Art

In a conventional technology relating to the fabrication of a microlens mold, a microlens mold is fabricated as follows. A mask layer is formed on the surface of a glass plate, and as many circular, fine openings as the number of the lenses to be fabricated are formed in the mask layer at positions corresponding to the lenses to be fabricated. The openings are then chemically etched to form substantially hemispherical concavities, and then the mask layer is entirely removed. Another mask layer is again formed on the surface of the plate where the concavities are formed, and circular openings larger than the size of the concavities are formed in the mask layer at positions corresponding to the concavities. The surface of the plate is further etched through the openings, and, after the mask layer is removed, the entire plate surface is etched (see Patent Document 1). In this way, a mold for a microlens having a smooth hybrid spherical surface can be fabricated with high precision. By increasing the number of times of formation of the mask layer, even more spherical surfaces can be provided.

Meanwhile, in a known art relating to the fabrication of an aspherical microlens, an Nb₂O₅ layer is deposited by sputtering on a SiO₂ substrate, for example. Then, a cylindrical pattern is formed on the Nb₂O₅ layer using a photoresist, and the cylindrical pattern is rendered hemispherical by postbaking. This is followed by plasma etching while controlling the etch gas mixture ratio, thereby transferring a lens shape onto the Nb₂O₅ layer (see Non-patent Document 1).

Patent Document 1: JP Patent Publication (Kokai) No. 7-63904 A (1995)

Non-patent Document 1: OplusE Vol. 24, No. 7 (July 2002), pp. 719-723

### SUMMARY OF THE INVENTION

As the recording density of optical discs keeps increasing and the size of optical disc drives keeps decreasing, there is a need for the fabrication of an aspherical microlens having a very small effective diameter and yet a sufficient thickness. Specifically, there is a demand for the realization of an aspherical microlens having an effective diameter of 1 mm or smaller and a thickness of 0.5 mm or greater.

In the process of fabricating a microlens mold according to Patent Document 1, one opening is provided for each lens, and a hemispherical concavity is formed by isotropic etching and used as a lens mold. Thus, this process is incapable of fabricating a mold for an aspherical lens, which is suitable for the correction of spherical aberration. The process of fabricating an aspherical microlens according to Non-patent Document 1 is capable of fabricating only thin lenses having a thickness on the order of 50 mm relative to an effective diameter of 300 mm.

Generally, a microlens is fabricated using a mold. However, no technology has yet been established that enables the fabrication of molds adapted to microlenses having the aforementioned dimensions.

Thus, it is an object of the invention to provide a process for fabricating a mold for the fabrication of an aspherical microlens having a smooth and any desired aspherical surface, with an effective diameter of 1 mm or smaller and a thickness of 0.3 mm or greater.

The invention is based on the inventors' realization through research and analysis that a microlens mold with desired dimensions can be obtained by the following process. Namely, a double-layer mask layer is formed on a single crystal silicon substrate, and then anisotropic etching and isotropic etching are carried out using a second mask layer, thereby forming a concavity of a size a little smaller than that of a desired microlens mold. Thereafter, isotropic etching is carried out using a first mask layer, thereby enlarging the concavity.

In one aspect, the invention provides a process for fabricating a mold for a microlens having a desired aspherical surface and a thickness greater than one half of the lens aperture. The process includes the steps of: forming a first mask layer on a silicon substrate such that it surrounds a circular region of a size smaller than the size of a concave portion of a mold to be fabricated; forming a second mask layer having a plurality of circular apertures on the circular region, the apertures having different sizes; carrying out anisotropic dry etching on the silicon substrate within the circular region through the circular apertures, thereby forming a plurality of holes in the silicon substrate having depths corresponding to the size of each circular aperture; carrying out isotropic etching on the silicon substrate within the circular region through the plurality of apertures so as to remove the side walls of the holes and thereby merge the holes; carrying out, after removing the second mask layer, isotropic etching on a concave portion formed by the merging of the holes, through the circular region in the first mask layer so as to enlarge the concave portion and smooth the surface thereof; and removing the first mask layer.

In another aspect, the invention provides a process for fabricating a mold for a microlens having a desired aspherical surface and a thickness greater than one half of the lens aperture, including the steps of: forming a first mask layer on a silicon substrate such that it surrounds a circular region of a size smaller than the size of the concave portion of a mold to be fabricated; forming a second mask layer on the circular region, the second mask layer having a plurality of apertures having different sizes; carrying out anisotropic dry etching on the silicon substrate within the circular region through the plurality of apertures; forming a plurality of holes in the silicon substrate having depths corresponding to the size of each of the circular apertures; carrying out, after removing the second mask layer, isotropic etching through the circular region of the first mask layer so as to remove the side walls of the plurality of holes, thereby merging the holes and forming a concave portion; and removing the first mask layer after the concave portion is formed.

In accordance with the process for fabricating a microlens mold according to the invention, after the first mask layer is removed, a layer is formed on the surface of the microlens mold, the layer having a good peeling property with respect to the preform for lens.

In accordance with the process for fabricating a mold for a microlens according to the invention, after the first mask layer is removed, a layer is formed on the surface of the microlens mold, the layer being resistant to the gas or liquid with which the silicon mold material is etched.

In yet another aspect, the invention provides a process for molding a microlens using a microlens mold fabricated by a process for fabricating a microlens mold according to the invention. The process includes the steps of: transferring the shape of the surface of the microlens mold having a desired aspherical surface onto a preform for lens; etching the side of the microlens mold opposite to the aforementioned surface so as to remove the silicon substrate; and removing the layer formed on the surface.

Thus, in accordance with the process for fabricating a microlens mold according to the invention, it becomes possible to fabricate an aspherical microlens having a desired, smooth aspherical surface and an effective diameter of 1 mm or smaller and a thickness of 0.3 mm or greater. Such aspherical microlens has so far been impossible to realize.

### BRIEF DESCRIPTION OF THE DRAWINGS

FIG. 1 shows a schematic flow of the process for fabricating a microlens mold according to the invention.

FIG. 2 shows a schematic flow of the process for fabricating a microlens mold according to another embodiment of the invention.

FIG. 3 shows a schematic flow of the process for molding a microlens using the microlens mold according to the invention.

FIG. 4 shows a schematic flow of the process for molding a microlens using the microlens mold according to the invention.

### DESCRIPTION OF THE PREFERRED EMBODIMENTS

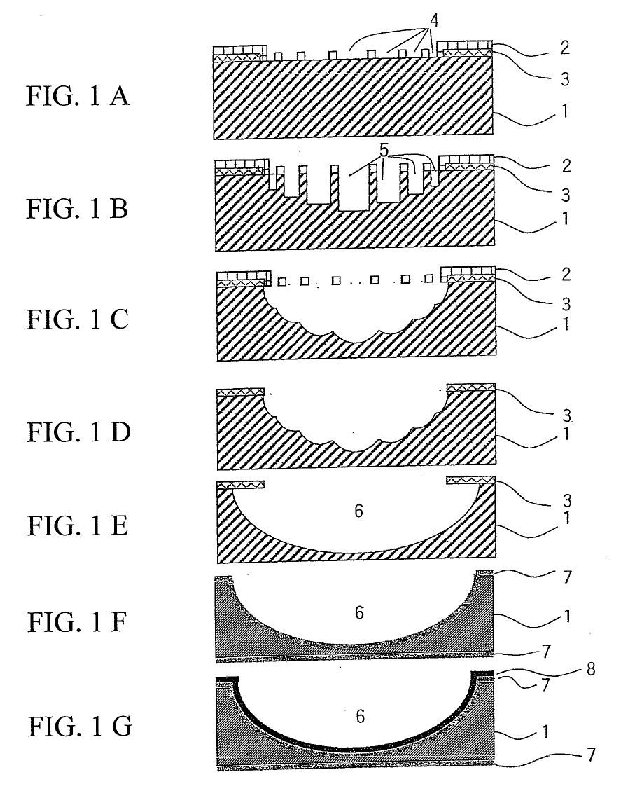

In the following, the process for fabricating a microlens mold according to the invention will be described by way of preferred embodiments and with reference to the attached drawings. FIG. 1 schematically shows the flow of the process of fabricating a microlens mold according to an embodiment of the invention.

First, as shown in FIG. 1(a), a double-layer etching mask composed of a first mask layer 3 and a second mask layer 2 is formed on a single crystal silicon substrate 1. Specifically, the first mask layer 3 is first formed on the single crystal silicon substrate 1 by depositing Al by sputtering, and then the second mask layer 2 of silicon oxide (e.g. silicon dioxide) is formed thereon. The first mask layer 3 is formed such that it surrounds a circular region of a smaller size than that of the region of the mold to be fabricated on the silicon substrate 1. The second mask layer 2 is formed in this circular region and on the areas surrounding it where the first mask layer 3 is formed. Thereafter, on the circular region where the second mask layer 2 is formed, a resist pattern having a plurality of circular apertures with different sizes for each lens are formed by photolithography. The second mask layer 2 is then etched using the resist pattern, thereby forming a plurality of circular apertures 4 with different sizes for each lens.

Then, as shown in FIG. 1(b), on the processed plane of the single crystal silicon substrate 1 where the mask layers have been formed, a plurality of holes 5 are formed in the silicon substrate 1 by anisotropic dry etching, using the opening pattern of the circular apertures 4 formed in the second mask layer 2. A microloading effect is involved here such that the greater the size of the circular aperture of the mask layer, the deeper the corresponding hole becomes, and the longer it takes for etching, the greater the difference in depth will be between the individual holes depending on the size of the circular aperture. Thus, the circular apertures 4 formed in the second mask layer 2 are designed such that they have greater sizes towards the lens center. Such microloading effect does not occur above a certain size of the circular apertures 4 in the mask layer. In the present embodiment, the size of the circular apertures 4 ranges from 5 μm to 40 μm.

The following are the conditions for anisotropic dry etching in the present embodiment: etching gas (SF₆) flow rate 120 sccm; passivation gas (C₄F₈) flow rate 80 sccm; percentage of venting 55%; source power 1000 W; RF power 110 W; pressure 1.7 to 1.8 Pa; and etching time to passivation time ratio 7:3.

Preferably, such anisotropic dry etching is carried out until the difference in depth between the deepest hole at a location corresponding to the lens center and the shallowest hole at a location corresponding to the periphery of the lens becomes 200 μm or greater.

In the present embodiment, the second mask layer is formed of a silicon oxide layer and the second mask layer is formed of aluminum. However, the same results can be obtained by forming the second mask layer of aluminum and the first mask layer of a silicon oxide layer or a silicon nitride layer.

Further, while in the present embodiment the first mask layer and the second mask layer are formed in an overlapped manner, the same results can be obtained as follows. Namely, a first mask layer alone is initially formed of aluminum, and then anisotropic dry etching and isotropic dry etching are carried out. The first mask layer is then removed and a second mask layer is formed of aluminum, followed by isotropic dry etching. In this case, the second mask may be formed of gold and then isotropic wet etching may be carried out, and the results would be the same.

Thereafter, as shown in FIG. 1(c), isotropic etching is carried out and the side walls of the multiple holes, which were formed in the silicon substrate 1 with different depths by the anisotropic dry etching in the former process, are removed, thereby merging the holes. The following are the conditions for isotropic dry etching in the present embodiment: etching gas (SF₆) flow rate 100 sccm; percentage of venting 55%; source power 900 W; RF power 20 W; and pressure 1.7-1.8 Pa.

This step can also be carried out by isotropic wet etching of single crystal silicon using a mixture of hydrofluoric acid, nitric acid, and acetic acid, for example, as well as by isotropic dry etching.

In the next step, as shown in FIG. 1(d), the second mask layer 2 is removed, and a smoothing process is carried out to smooth the mold surface. The smoothing process can be carried out by isotropic dry etching or isotropic wet etching, for example.

This is followed by isotropic etching, as shown in FIG. 1(e), whereby a concave mold 6 for lens is formed. This concave mold 6 for lens has a greater size than the concave portion formed in the step of FIG. 1(d).

Then, as shown in FIG. 1(f), the first mask layer 3 is removed, and a passivation layer 7 is formed on the surface of the concave mold 6 for lens, the passivation layer 7 being resistant to the gas or liquid that etches silicon. The passivation layer 7 may be formed of aluminum or silicon oxide, for example.

In the next step, as shown in FIG. 1(g), a layer 8 is formed on the surface of the concave mold 6 for lens that has a good peeling property with respect to the preform for lens. The layer 8 may be made of carbon when the preform for lens is glass, for example. Such layer makes it easier to peel the microlens from the microlens mold after transfer.

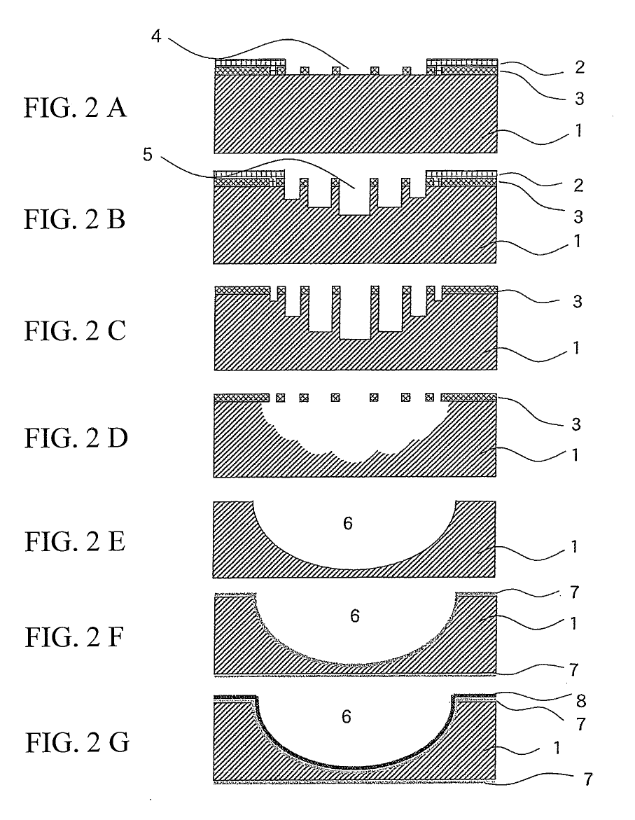

FIG. 2 schematically shows the flow of the microlens mold fabrication process according to another embodiment of the invention.

First, a double-layer etching mask composed of a first mask layer 3 and a second mask layer 2 is formed on the single crystal silicon substrate 1, as shown in FIG. 2(a). Specifically, the first mask layer 3 is first formed on the single crystal silicon substrate 1 by depositing a layer of Al, and then the second mask layer 2, which is made of a silicon oxide layer, is formed thereon. The first mask layer 3 is formed such that a plurality of circular apertures having different sizes are formed in the circular region of a mold to be fabricated in the silicon substrate 1. The second mask layer 2 is formed on the first mask layer 3 such that it covers the plurality of circular apertures that exist at the periphery of the circular region.

Next, as shown in FIG. 2(b), using the surface of the single crystal silicon substrate 1 where the mask layer is formed as a processed plane, a plurality of holes 5 are formed in the silicon substrate 1 by anisotropic dry etching through those of the multiple circular apertures 4 formed in the first mask layer 3 that are not covered by the second mask layer 2, each of the holes having a depth corresponding to the size of each circular aperture 4. In the present embodiment, the size of the circular apertures 4 ranges from 5 μm to 40 μm. The conditions for anisotropic dry etching in the present embodiment are the same as those of the foregoing embodiment.

Thereafter, as shown in FIG. 2(c), the second mask layer 2 is removed and all of the circular apertures in the first mask layer 3 are opened. By anisotropic dry etching through these circular apertures and the previously formed holes 5, the difference in depth between the holes at the center of the lens and those at the periphery thereof increases.

Next, as shown in FIG. 2(d), isotropic etching is carried out to remove the side walls of the multiple holes with different depths formed in the silicon substrate 1 by the anisotropic dry etching in the preceding step, thereby merging the holes. The conditions for isotropic dry etching in the present embodiment are the same as those of the preceding embodiment.

Then, as shown in FIG. 2(e), the first mask layer 3 is removed, followed by smoothing process in order to smooth the surface of the mold.

In the next step, as shown in FIG. 2(f), a passivation layer 7 for curing the mold is formed on the surface of the concave mold 6 for lens. The passivation layer may be formed of silicon oxide, for example.

A layer 8 having a good peeling property with respect to the preform for lens is then formed on the surface of the concave mold 6 for lens, as shown in FIG. 2(g). The layer 8 may be made of a carbon material when the preform for lens is glass, for example.

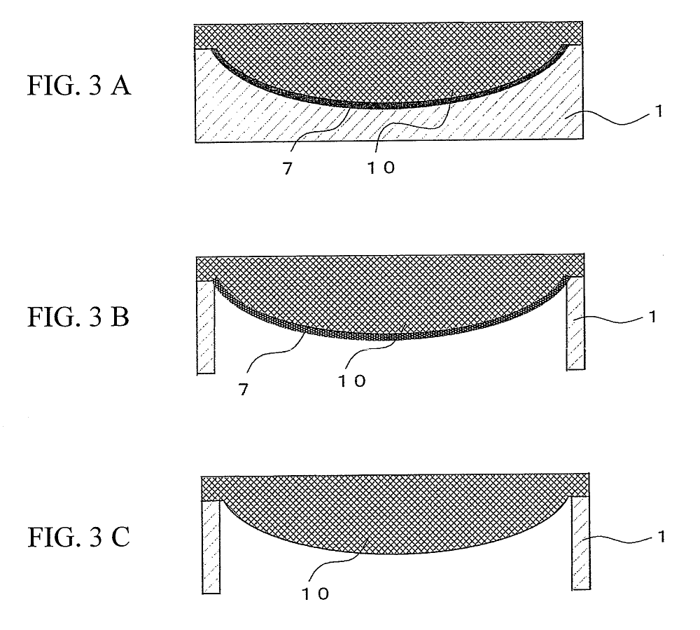

With the use of a microlens mold thus fabricated, a microlens can be molded in the following procedure. As shown in FIG. 3(a), after transferring the preform for lens 10 onto the microlens mold formed in the silicon substrate 1, the silicon substrate 1 is etched from the opposite side of the mold, as shown in FIG. 3(b). Then, as shown in FIG. 3(c), the passivation layer 7 is removed, whereby the lens surface can be exposed without peeling the microlens from the microlens mold. In this way, a microlens can be molded without scratching the lens surface.

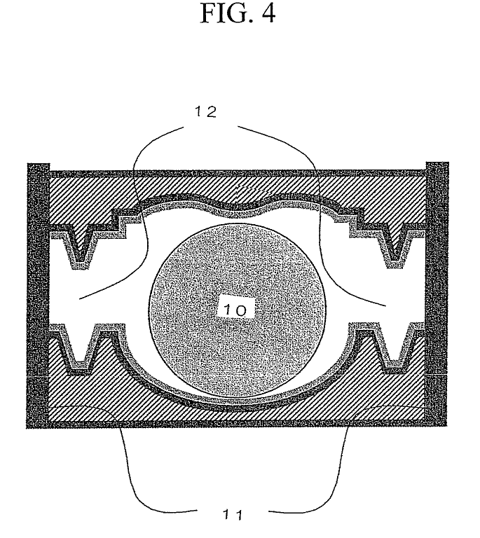

Further, by using the thus fabricated microlens mold, a microlens can be molded in the following way. As shown in FIG. 4, the preform for lens 10 is sandwiched between two molds formed of a silicon substrate. The molds are then pressed against each other while they are heated, using a coarse adjusting mechanism 11 and a fine adjusting mechanism 12 such that their lens central axes are aligned. The fine adjusting mechanism 12 may be formed by etching the silicon substrate when forming the lens mold.

As described above, in accordance with the present embodiment, the size and position of the circular apertures 4, and the duration of each etching step are appropriately designed such that a mold for molding a microlens having a desired aspherical surface and thickness can be formed. Specifically, a mold can be fabricated for molding an aspherical microlens having an effective diameter of 1 mm or smaller and a thickness of 0.3 mm or greater. Furthermore, a microlens mold having a smooth surface can be obtained by the smoothing process.

While the invention has been particularly shown and described with reference to the preferred embodiment thereof, it will be understood by those skilled in the art that the foregoing and other changes in form and detail may be made therein without departing from the spirit and scope of the invention.

What is claimed is:

1. A process of fabricating a mold for a microlens having a desired aspherical surface and a thickness greater than one half of the lens aperture, comprising the steps of:
forming a first mask layer on a silicon substrate in such a shape that it surrounds a circular region that is smaller than the size of a concave portion of a mold to be fabricated;
forming a second mask layer on the circular region, the second mask layer having a plurality of circular apertures with different sizes;
carrying out anisotropic dry etching on the silicon substrate within the circular region through the circular apertures so as to form a plurality of holes in the silicon substrate having depths corresponding to the size of each circular aperture;
carrying out isotropic etching on the silicon substrate within the circular region through the circular apertures so as to remove the side walls of the holes and thereby merge the holes;
removing the second mask layer;
carrying out isotropic etching on a concave portion formed by the merging of the holes, through the circular region in the first mask layer;
enlarging the concave portion;
smoothing the surface of the concave portion; and
removing the first mask layer.

2. The process for fabricating a microlens mold according to claim 1, comprising the step of forming, after removing the first layer, a layer on the surface of the microlens mold, the layer having a good peeling property with respect to a preform for lens.

3. The process for fabricating a microlens mold according to claim 1, comprising the step of forming, after removing the first mask layer, a layer on the surface of the microlens mold, the layer being resistant to a gas or liquid with which the silicon mold material is etched.

4. A process for fabricating a microlens mold using a microlens mold fabricated by the microlens mold fabricating process according to claim 2, comprising the steps of:
transferring the shape of the one surface of the microlens mold having a desired aspherical surface, to a preform for lens;
removing the silicon substrate by etching the other surface of the microlens mold opposite the one surface; and
removing the layer formed on the one surface.

5. A process of fabricating a mold for a microlens having a desired aspherical surface and a thickness greater than one half of the lens aperture, comprising the steps of:
forming a first mask layer on a silicon substrate in such a shape that it surrounds a circular region that is smaller than the size of a concave portion of a mold to be fabricated;
forming a second mask layer on the circular region, the second mask layer having a plurality of circular apertures with different sizes;
carrying out anisotropic dry etching on the silicon substrate within the circular region through the circular apertures so as to form a plurality of holes in the silicon substrate having depths corresponding to the size of each circular aperture;
removing the second mask layer;
carrying out isotropic etching through the circular region of the first mask layer so as to remove the side walls of the holes, thereby merging the holes and forming a concave portion; and
removing the first mask layer.

6. The process for fabricating a microlens mold according to claim 5, comprising the step of forming, after removing the first layer, a layer on the surface of the microlens mold, the layer having a good peeling property with respect to a preform for lens.

7. The process for fabricating a microlens mold according to claim 5, comprising the step of forming, after removing the first mask layer, a layer on the surface of the microlens mold, the layer being resistant to a gas or liquid with which the silicon mold material is etched.

8. A process for fabricating a microlens mold using a microlens mold fabricated by the microlens mold fabricating process according to claim 6, comprising the steps of:
transferring the shape of the one surface of the microlens mold having a desired aspherical surface, to a preform for lens;
removing the silicon substrate by etching the other surface of the microlens mold opposite the one surface; and
removing the layer formed on the one surface.

9. A process of fabricating a mold for a microlens having a desired aspherical surface and a thickness greater than one half of the lens aperture, comprising the steps of:
forming a first mask layer on a silicon substrate, the first mask layer having a plurality of circular apertures with different sizes in a circular region corresponding to a concave portion of a mold to be fabricated;
forming a second mask layer such that it covers a plurality of circular apertures that exist at the periphery of the circular region;
carrying out anisotropic dry etching on the silicon substrate within the circular region through those of the circular apertures that are not covered by the second mask layer so as to form a plurality of holes in the silicon substrate having depths corresponding to the size of each circular aperture;
removing the second mask layer;
carrying out anisotropic dry etching on the silicon substrate within the circular region through all of the circular apertures within the circular region, so as to form a plurality of holes in the silicon substrate having different depths;
carrying out isotropic etching on the silicon substrate within the circular region through the circular apertures so as to remove the side walls of the holes and thereby merge the holes;
removing the first mask layer; and
smoothing the surface of the concave portion formed by the merging of the holes by isotropic etching.

10. The process for fabricating a microlens mold according to claim 9, comprising the step of forming, after removing the first layer, a layer on the surface of the microlens mold, the layer having a good peeling property with respect to a preform for lens.

11. The process for fabricating a microlens mold according to claim 9, comprising the step of forming, after removing the first mask layer, a layer on the surface of the microlens mold, the layer being resistant to a gas or liquid with which the silicon mold material is etched.

12. A process for fabricating a microlens mold using a microlens mold fabricated by the microlens mold fabricating process according to claim 10, comprising the steps of:
transferring the shape of the one surface of the microlens mold having a desired aspherical surface, to a preform for lens;
removing the silicon substrate by etching the other surface of the microlens mold opposite the one surface; and
removing the layer formed on the one surface.
